(19) United States
(12) Patent Application Publication
(10) Pub. No.: US 2010/0198865 A1
(43) Pub. Date: Aug. 5, 2010

(54) SYSTEM AND METHOD FOR DETECTING, MANAGING, AND PREVENTING LOCATION INFERENCE IN ADVERTISING OVER A COMMUNICATIONS NETWORK

(75) Inventors: Nicolas St-Pierre, Toronto (CA); Michael Ho, Toronto (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(73) Assignee: Bering Media Incorporated, Toronto (CA)

(21) Appl. No.: 12/692,751

(22) Filed: Jan. 25, 2010

Related U.S. Application Data
(60) Provisional application No. 61/148,434, filed on Jan. 30, 2009.

(51) Int. Cl. G06F 17/30

(52) U.S. Cl. 707/769; 707/E17.014

(57) ABSTRACT

A method and apparatus for preventing inference of at least one unique identifier associated with a subscriber in an advertising communication network. The method comprises providing targeting criteria from an advertising server to a matching database; providing the at least one unique identifier from a subscriber database to the match database; identifying a subscriber intersection at the match database, the subscriber intersection related to the at least one unique identifier and the targeting criteria; and selectively removing the at least one unique identifier associated with the subscriber intersection from the match database, such that the at least one unique identifier is no longer accessible by the advertising server from the match database.

### CROSS REFERENCE TO RELATED APPLICATIONS

This applications claims priority from U.S. Provisional Application No. 61/148,434 filed on Jan. 30, 2009.

### FIELD

The present disclosure relates generally to a method and system for detecting, managing and preventing location inference over a communications network, in furtherance of privacy-related considerations.

### BACKGROUND

Given the proliferation of on-line advertising and commerce, privacy laws have been legislated into existence as a result of public policy considerations related to expectations of personal privacy. For instance, the physical location of a participant or consumer engaged in on-line commerce, or targeted for on-line advertising, may be considered strictly private. Especially when intermediary parties may be involved in a transaction or targeted advertising, not all such parties may require access to, or knowledge of the targeted party's physical location. In such cases, compliance with the applicable privacy laws, and indeed compliance with the privacy expectations of the targeted party at a minimum, may require knowledge of physical location to be available strictly to only a subset of the parties involved.

To the extent that the tools for ensuring compliance with privacy laws are effective with regard to personal information disclosed, the public's confidence in, and acceptance of, on-line advertising and transactions performed over a communications network will be furthered.

### SUMMARY OF THE INVENTION

Provided is a method for preventing inference of at least one unique identifier associated with a subscriber in a communication network. The method comprises providing targeting criteria from an advertising server to a matching database; providing the at least one unique identifier from a subscriber database to the match database; identifying a subscriber intersection at the match database, the subscriber intersection related to the at least one unique identifier and the targeting criteria; and selectively removing the at least one unique identifier associated with the subscriber intersection from the match database, such that the at least one unique identifier is no longer accessible by the advertising server from the match database.

Also provided is a system for preventing inference of at least one unique identifier associated with a subscriber in a communication network. The system comprises an advertising server for providing targeting criteria; a subscriber database for providing the at least one unique identifier; a match database for identifying at least one subscriber intersection at the match database, the subscriber intersection related to the at least one unique identifier and the targeting criteria, wherein the at least one unique identifier is selectively removed from the match database such that is no longer accessible by the advertising server.

### BRIEF DESCRIPTION OF THE DRAWINGS

Embodiments will now be described by way of example only, with reference to the following drawings in which:

FIG. 1 illustrates an exemplary system for preventing inference of a unique identifier associated with a subscriber in a communication network;

FIG. 2 is an exemplary conceptual intersect diagram illustrating removal of the unique identifier; and

FIG. 3 is an conceptual diagram showing an exemplary non-intersect diagram illustrating after removal of the unique identifier.

### DETAILED DESCRIPTION

The present invention is a system and method for detecting, managing and preventing location inference in advertising over a communications medium, including methods for isolating advertising target groups, finding and selecting logical and physical intersections of target groups and implementing embodiments of mechanisms for preventing the inference of one or a plurality of members within a target group.

The use of such a method can be used, but not limited to, in the context of Internet based online advertising where targeting information such as the geography, or physical location of the member recipients is used as a determining factor for selection of the online advertising content to be displayed. In a exemplary environment of this nature, there may exist a commercial relationship between parties A, B and C involved in the advertising system targeting a subscriber. For illustration purposes, party A may be providing the target group information, such as but not limited to geographical location of the subscriber through a location broker. Party B may provide advertising content delivery such as graphical creative and a third party C may provide a transaction system between A and B by managing a match or transaction database. In such a system, where the the third party C's transaction system is used for every transaction requiring information from either party A or B. the commercial relationship between the parties may depend on the safeguard of privacy of each party's information property.

In the exemplary environment described, the third party C providing a transaction system may need to provide system and methods to guard against the inference, learning, or detection, of each party A and B property through accidental or intended transactions over varying short or long periods of time.

The system described in this application details a system and method that a party C would use to detect, manage and prevent the possibility of detection, inference or learning by analyzing the information contained in the transactions between parties and modifying the information in such a way that it can no longer be used to infer, learn or otherwise detect the geography, or physical location, of a subscriber member. For instance, the location information of such a subscriber member, if such information was used multiple times by another party, and recorded or remained present after such usage by that party, its location inference might therefore be made possible by determination of intersecting geographical areas.

In the following description, for purposes of explanation, numerous specific details are set forth in order to provide a thorough understanding of the present invention. It will be evident, however, to one skilled in the art that the present invention may be practiced without these specific details. Thus, the invention is not intended to be limited to the specific details, and is to be accorded the widest scope consistent with the principles and features disclosed herein.

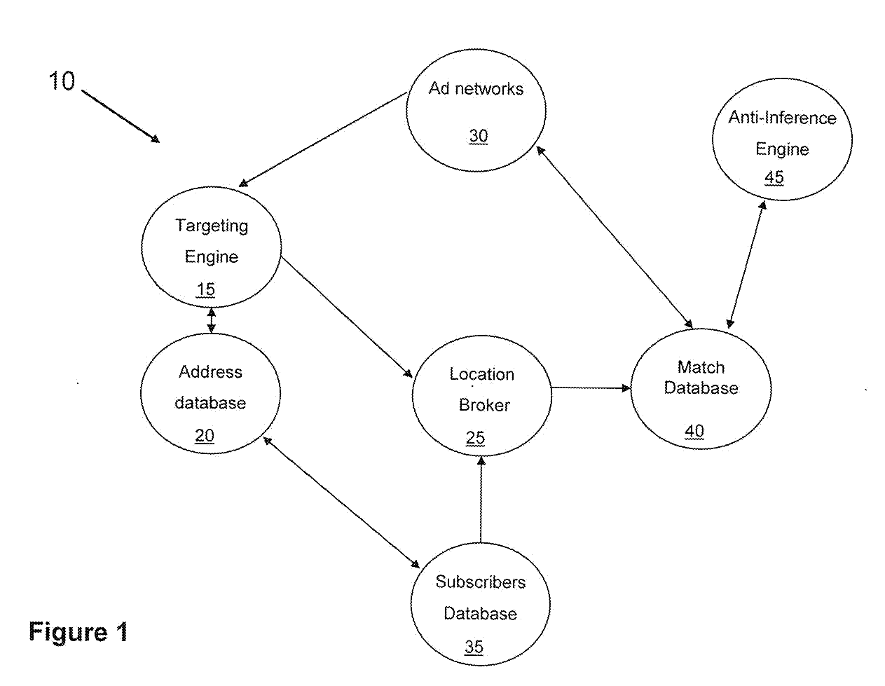

Referring now to the drawings, the overview in FIG. 1 shows a local advertising system 10 comprising targeting engine 15, address database 20, as well as location broker 25, advertising (hereinafter “Ad”) network 30, and a plurality of subscriber, subscriber identifiers, physical location or otherwise unique labels sourced from subscriber database 35, hereinafter “unique identifier”, all connected via a communications medium. In a preferred embodiment, the communications medium contemplated is the Internet.

However, the present invention contemplates the use of any other type of communications medium which include, without limitation, a local area network, a wide area network, a wireless network, a proprietary network, or the like.

An embodiment of the present invention may comprise one or more special purpose or general-purpose computers or servers, each of which may include, but are not limited to, one or more processors, memories, storage devices, input/output devices and a network interface. For the purposes of explanation, the terms ‘computer’ and ‘server’ may be interchangeable in accordance with the above description.

Furthermore, the present invention may be implemented as computer software in the form of computer readable code executed in memory by processors on one or more of the computers or servers contemplated above. Although the present invention is illustrated in FIG. 1 as separate components, it should be understood that various components could be combined into a single computer or server, or implemented across multiple computers or servers all connected via a communications medium (such as the Internet) without departing from the scope of the present invention.

Targeting engine 15 provides a set of location based criteria capability to Ad network 30 wishing to identify a set of unique identifiers that fall within a range of physical location to effectively focus a local advertising campaign. Ad network 30 may comprise any entity that uses advertising, such as, and including, an advertising agency, an advertiser, or advertising server technology. In one exemplary embodiment, the targeting engine 15 provides an Ad network 30 with a set of readily identifiable locality criteria such as physical or mailing address, a distance radius from such an address, other generally accepted locality identifier such as, but not limited to, a mailing ZIP code with or without extension, a government district, telephone dialling area code or (hereinafter “targeting criterion”). The targeting engine 15 provides a method for Ad network 30 to correlate with external data by using a common link such as, but not limited to, the subscriber mailing address. To do so, the targeting engine 15 can rely on a common data store such as subscriber database 35 containing the correlation and common link information such as, but not limited to, ZIP codes, addresses, phone numbers, district, to the mapped physical location expressed in types such as, but not limited to, geographical coordinates containing latitude, longitude and altitude.

The targeting engine 15 gathers one or a plurality of targeting criterion and generates one or a plurality of logical or geographical contiguous areas within which a subscriber physical address information contained in one or a plurality of subscriber database 35 must be physically located in order to be included in the resulting Match Database 40.

The location broker 25 of the present invention receives the single or plurality of computed logical contiguous areas from the targeting engine 15. The location broker 25 also receives a set of common location identifiers from subscriber database 35 which contains one, or a plurality of, potentially addressable customer location information.

The location broker 25 of this present invention processes each subscriber location information from the subscriber database 35 against the matching criteria of the targeting engine 15. The resulting set of subscriber information contained in the subscriber database 35 matching the location criteria supplied by the Ad network 30 to the targeting engine 15 are then stored in a match database 40.

The match database 40 of this present invention operates a repository for a single or plurality of separate targeting criteria matches containing a single, or a plurality of, subscriber list for which a location broker 25 has previously identified as being located within a geographical area targeted by Ad network 30.

The Anti-Inference engine 45 in this present invention analyzes all stored matching sets of target criteria in the match database 40 for a given Ad network 30. The Anti-Inference engine 45 finds all occurrences of a single, or plurality of, unique identifier found in a plurality of matching sets (hereinafter “subscriber intersection”).

When the Anti-Inference engine 45 detects a unique identifier intersection occurring in a single or plurality of match database 40, one, or a plurality of, algorithm is used to selectively remove the aforementioned unique identifier from one, or plurality of, matching set in the Match database 40. The modifications applied to the Match database 40 by the Anti-Inference engine 45 results in a new singular or plurality of matching sets where unique identifiers such as subscriber location cannot be inferred by an Ad network 30 supplying intersects of matching criteria into the Targeting engine 15 with the intent, intentional or otherwise, to identify one, or a plurality of, unique identifier location information.

The match database 40 also operates a matching service for the Ad network 30 in which the Ad network 30 can query the match database with a unique identifier. The match database 40 processes the query from the Ad Network 30 and returns one, or a plurality of, name of sets in which the unique identifier is found.

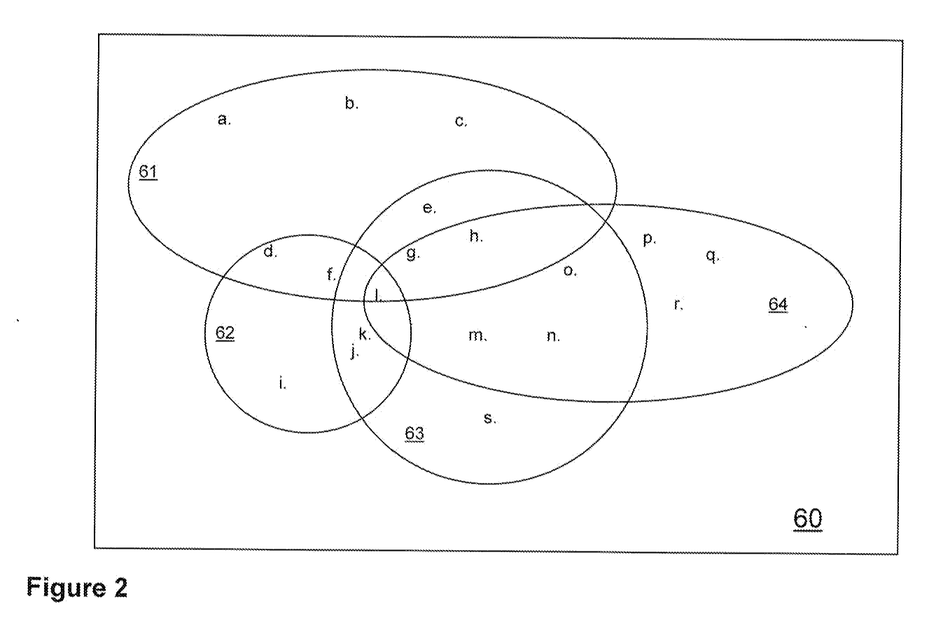

An embodiment of the Anti-Inference engine 45 in this invention is detailed in FIG. 2, where the intersect diagram 60 represents the plurality of an Advertising network targeting criteria populated in the match database 40 by the targeting engine 15. Each singular targeting criteria 61-64 embodies a set of a singular, or a plurality of, unique identifiers named a. to s. within each set of an Ad network 30. The Anti-Inference engine 45 analyzes the unique identifiers a. to s. found in the match database 40 and represented in the intersect diagram 60.

When the Anti-inference engine 45 detects subscriber intersection in the intersect diagram such as unique identifier l. in the intersect diagram 60 which intersects sets 61, 62, 63 and 64, it selectively removes the unique identifier from one or a plurality of sets through the use of one or a plurality of algorithm.

One such exemplary algorithm used on the intersect diagram 60 of FIG. 2 would detect any unique identifiers a. to s. intersecting, or being member of more than a unique set 61 to 64. For each intersecting unique identifier a. to s., the algorithm would first remove the unique identifier with the most set intersection from all but 1 intersecting set. In the embodiment 50 presented, this such unique identifier l. in intersect diagram 60 intersects the totality of sets 61 to 64 and is therefore removed from all sets except 1 chosen at random.

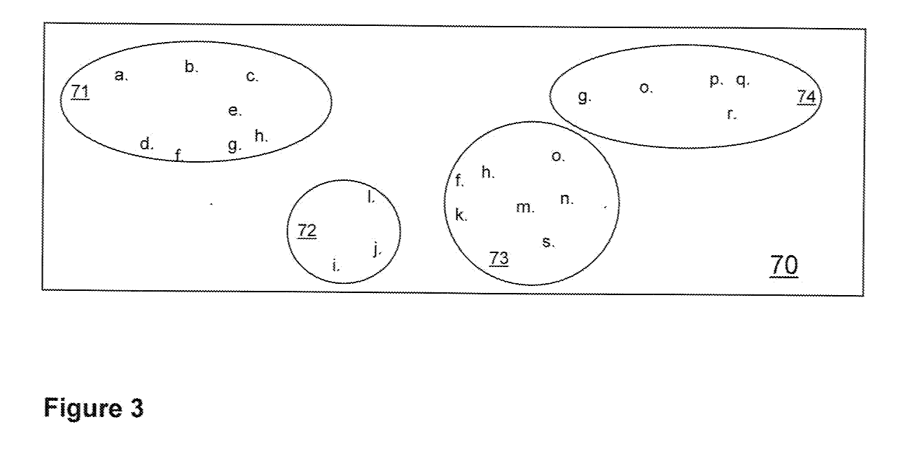

Now with reference to FIG. 3, the resulting sets generated by the Anti-Inference engine 45 using the exemplary algorithm described is detailed in the non-intersect diagram 70. The resulting set 72 of the non-intersect diagram 70 represents the only set with the unique identifier l. as a member. In a further operation, the algorithm will then selectively remove unique identifiers a. to s. from at least 1 set from which it is a member of unless there are 3 or more unique identifiers with identical set intersection. The resulting removal of unique identifiers from sets represented of non-intersect diagram 70 demonstrates that while unique identifier d. was previously a member of set 61 and 62 in Venn diagram 60, it is only a member of set 71. Similarly, the unique identifier h. which is a member of set 61, 63 and 64 in Venn Diagram 60 is now a member of set 71 and 73.

In the non-intersect diagram 70, unique identifiers a. to s. which were previously part of a singular or plurality of set intersects in the intersect diagram have been selectively removed from a singular or plurality of sets 71, 72, 73 and 74, such as unique identifier l. which is now a member of set 72. In this embodiment, the anti-inference engine 45 has also selectively preserved existing intersects of a singular, or plurality of, sets, such as unique identifier f. which is found to intersect sets 61, 62 and 63 in the intersect diagram 60, and intersects only sets 71, 73 but not 72 in the non-intersect set.

The foregoing detailed description should be regarded as illustrative rather than limiting. It should be appreciated by those skilled in the art, in light of the present disclosure, that many changes can be made in the specific embodiments which are disclosed and still obtain a like or similar result without departing from the spirit and scope of the invention.

What is claimed is:

1. A method for preventing inference of at least one unique identifier associated with a subscriber in a communication network, the method comprising:
providing targeting criteria from an advertising server to a matching database;
providing the at least one unique identifier from a subscriber database to the match database;
identifying at least one subscriber intersection at the match database, the subscriber intersection related to the at least one unique identifier and the targeting criteria; and
selectively removing the at least one unique identifier associated with the at least one subscriber intersection from the match database;
wherein the at least one unique identifier is no longer accessible by the advertising server from the match database.

2. The method of claim 1 wherein the at least one unique identifier associated with the subscriber comprises a physical location of the subscriber.

3. The method of claim 1 wherein at least one of the targeting criteria is selected from the list of locality criteria consisting of: physical address, mailing address, a distance radius from an address, a postal code, a telephone area code and a district.

4. The method of claim 1 wherein the match database operates a matching service in which the advertising server queries the match database using a unique identifier, and the match database returns at least one set of names in which the unique identifier is found.

5. The method of claim 5 wherein selectively removing the at least one unique identifier comprises removing the at least one unique identifier associated with the highest number of subscriber intersections.

6. The method of claim 1 wherein selectively removing the at least one unique identifier comprises removing the plurality of unique identifiers associated with a subscriber intersection except for one chosen at random.

7. A computer memory having instructions stored thereon, which, when executed in a processor, performs the method of claim 1.

8. A system for preventing inference of at least one unique identifier associated with a subscriber in a communication network, the system comprising:
an advertising server for providing targeting criteria;
a subscriber database for providing the at least one unique identifier; and
a match database for identifying at least one subscriber intersection at the match database, the subscriber intersection related to the at least one unique identifier and the targeting criteria;
wherein the at least one unique identifier is selectively removed from the match database such that is no longer accessible by the advertising server.

9. The system of claim 8 wherein the at least one unique identifier associated with the subscriber comprises a physical location of the subscriber.

10. The system of claim 8 wherein at least one of the targeting criteria is selected from the list of locality criteria consisting of: physical address, mailing address, a distance radius from an address, a postal code, a telephone area code and a district.

11. The system of claim 8 wherein the match database operates a matching service in which the advertising server queries the match database using a unique identifier, and the match database returns at least one set of names in which the unique identifier is found.

12. The system of claim 8 wherein selectively removing the at least one unique identifier comprises removing the at least one unique identifier associated with the highest number of subscriber intersections.

13. The system of claim 8 wherein selectively removing the at least one unique identifier comprises removing the plurality of unique identifiers associated with a subscriber intersection except for one chosen at random.

14. The system of claim 8 wherein the communications network is selected from the group of networks consisting of a local area network, a wide area network, a wireless network and a proprietary network.
